(19) United States
(12) Patent Application Publication
(10) Pub. No.: US 2016/0071385 A1
(43) Pub. Date: Mar. 10, 2016

(54) POINT OF SALE LANE GATE

(71) Applicant: Checkpoint Systems, Inc., Thorofare, NJ (US)

(72) Inventors: Darren Chave, Wantirna South (AU); Mark Gentle, Wantirna South (AU)

(21) Appl. No.: 14/846,861

(22) Filed: Sep. 7, 2015

Related U.S. Application Data
(60) Provisional application No. 62/046,367, filed on Sep. 5, 2014.

(51) Int. Cl. G08B 13/24

(52) U.S. Cl. CPC G08B 13/2402

(57) ABSTRACT

In one embodiment, the invention can be an apparatus for a point of sale (POS) lane gate, the apparatus including a frame; a translation mechanism coupled to the frame and configured to transition the frame between an extended position and an unextended position, wherein in the extended position the frame extends into the POS lane and obstructs a person's passage through the POS lane, and in the unextended position the frame does not obstruct a person's passage through the POS lane; and an EAS antenna coupled to the frame; wherein when the frame is in the unextended position, the EAS antenna is in an active state such that the EAS antenna generates an EAS field in the POS lane; and wherein when the frame is transitioned from the unextended position to the extended position, the EAS antenna transitions to an inactive state.

### CROSS REFERENCE TO RELATED APPLICATIONS

The present application claims priority to U.S. Provisional Patent Application Ser. No. 62/046,367, filed Sep. 5, 2014, the entirety of which is incorporated herein by reference.

### BACKGROUND

Retail stores typically have numerous point of sale (POS) stations where customers purchase chosen items. Each POS station has a lane or walkway whereby the customer approaches the POS. At different times, particularly off-peak times, certain POS stations will be inactive and unmanned. To prevent thieves with stolen goods from easily exiting the store through inactive POS lanes, these lanes will often be provided a physical barrier to obstruct passage through the POS lane. For example, a metal chain can extend across the POS lane to prevent a thief from easily exiting. Such chains and other barriers, however, are limited in functionality. Thus, there exists a need for a physical barrier that provides additional functionality, including additional security functionality.

### BRIEF SUMMARY

The present disclosure is directed to an apparatus, system, and method for a POS lane gate. In one aspect, the apparatus includes a frame; a translation mechanism coupled to the frame and positioned adjacent a POS lane, the translation mechanism configured to transition the frame between an extended position and an unextended position, wherein in the extended position the frame extends into the POS lane and obstructs a person's passage through the POS lane, and in the unextended position the frame does not obstruct a person's passage through the POS lane; and an EAS antenna coupled to the frame, the EAS antenna configured to operably couple to EAS field generation hardware; wherein when the frame is in the unextended position, the EAS antenna is in an active state such that the EAS antenna generates an EAS field in the POS lane; and wherein when the frame is transitioned from the unextended position to the extended position, the EAS antenna transitions to an inactive state such that the EAS antenna does not generate an EAS field in the POS lane.

In another aspect, a system includes a gate comprising a frame; a translation mechanism coupled to the frame and positioned adjacent a POS lane, the translation mechanism configured to transition the frame between an extended position and an unextended position, wherein in the extended position the frame extends into the POS lane and obstructs a person's passage through the POS lane, and in the unextended position the frame does not obstruct a person's passage through the POS lane; an EAS antenna coupled to the frame; and EAS field generation hardware operably coupled to the EAS antenna; wherein when the frame is in the unextended position, the EAS antenna is in an active state such that the EAS antenna generates an EAS field in the POS lane; and wherein when the frame is transitioned from the unextended position to the extended position, the EAS antenna transitions to an inactive state such that the EAS antenna does not generate an EAS field in the POS lane.

In yet another aspect, a method includes providing a gate comprising a frame; a translation mechanism coupled to the frame and positioned adjacent a POS lane, the translation mechanism configured to transition the frame between an extended position and an unextended position, wherein in the extended position the frame extends into the POS lane and obstructs a person's passage through the POS lane, and in the unextended position the frame does not obstruct a person's passage through the POS lane; an EAS antenna coupled to the frame; operably coupling EAS field generation hardware to the EAS antenna; transitioning the frame from the unextended position to the extended position; and in response to transitioning the frame from the unextended position to the extended position, transitioning the EAS antenna from (a) an active state in which the EAS antenna generates an EAS field in the POS lane to (b) an inactive state in which the EAS antenna does not generate an EAS field in the POS lane.

### BRIEF DESCRIPTION OF THE DRAWINGS

The invention of the present disclosure will become more fully understood from the detailed description and the accompanying drawings, wherein:

FIG. 1 is a perspective view of a POS station according to one embodiment of the present invention.

FIG. 2 is a top view of the POS station of FIG. 1 where the gate has been transitioned to the unextended position.

FIG. 3 is a front view of the gate of FIG. 1.

FIGS. 4A-4C are the gate of FIG. 1 transitioning to an unextended position.

FIGS. 5A-5D are different antenna configurations according to different embodiments of the present invention.

FIG. 6 is a schematic of an antenna switchably coupled to EAS field generation hardware according to one embodiment of the present invention.

FIG. 7 is a flow chart of a method according to one embodiment of the present invention.

### DETAILED DESCRIPTION

The following description of the preferred embodiment(s) is merely exemplary in nature and is in no way intended to limit the invention. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and similar refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features.

According to various example embodiments, a multi-function POS gate is described. The gate may provide a movable barrier to a POS lane, as well as Electronic Article Surveillance (EAS) functionality.

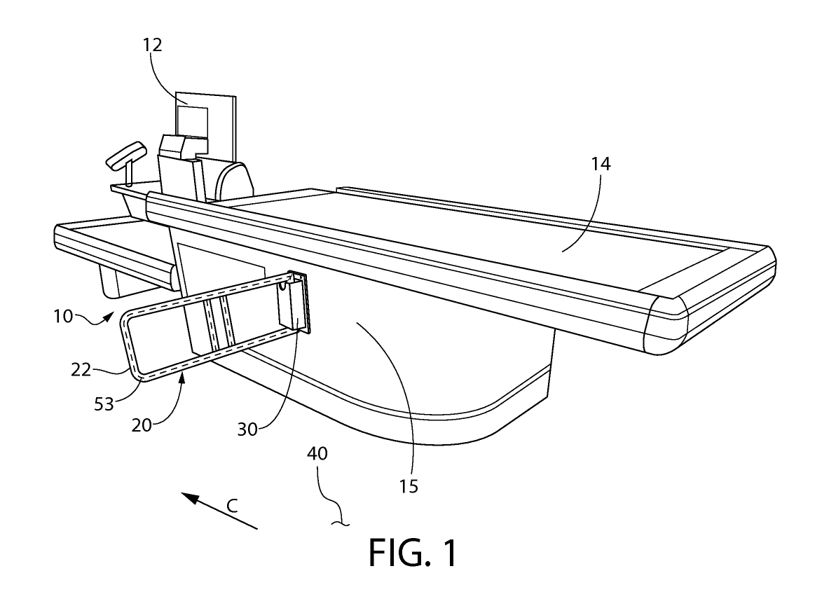

Referring now to FIG. 1, a POS station 10 according to one embodiment of the present invention is shown. The POS station 10 of the exemplified embodiment includes a register 12, a scanner 13, and a conveyor system 14. Generally, a customer can travel down the POS lane 40 in the direction C and place the items he wants to purchase on the conveyor system 14. The conveyor system 14 can transport the goods to the scanner 13, where the items are scanned. In the exemplified embodiment, the scanner 13 is a bar code scanner. A store clerk can finalize the purchase at the register 12. The invention, however, is not so limited. In other embodiments, the POS station can be any system for consummating purchase of an item. Components such as a scanner 13 and conveyor system 14 can be omitted or replaced with other components. If the POS station offers self-checkout, the POS station can operate without the assistance of a store clerk. Further, the POS lane 40 can be any walkway that enables a customer physical access to a POS.

In the exemplified embodiment, the POS station 10 also includes a gate 20 (sometimes referred to as an “apparatus”). The gate 20 includes a frame 22 and a translation mechanism 30. In this embodiment, the frame 22 comprises hollow tubing, with an Electronic Article Surveillance (EAS) antenna 53 positioned within. The gate 20 and its EAS antenna 53 will be discussed in more detail below.

The translation mechanism 30 is coupled to the frame 22 and positioned adjacent the POS lane 40. The translation mechanism 30 is configured to transition the frame 22 between an extended position and an unextended position. In the extended position (shown in FIG. 1) the frame 22 extends into the POS lane 40 and obstructs a person's passage through the POS lane 40. By contrast, in the unextended position the frame 22 does not obstruct a person's passage through the POS lane 40.

In this embodiment, the translation mechanism 30 is a swivel mechanism configured to swivel the frame 22 between the extended position and the unextended position. The swivel mechanism 30 is configured to attach to the stationary and substantially vertical surface 15 adjacent the POS lane 40, and is discussed in more detail below. In other embodiments, the translation mechanism can be any mechanism configured to transition the frame between an extended position (that obstructs passage through a POS lane 40) and an unextended position (that does not obstruct passage through a POS lane 40). For example, the translation mechanism can enable a gate to fold out into a POS lane, or lift from the floor below a POS lane, or emerge from under the conveyor belt of the conveyor system.

The EAS antenna 53 coupled to the frame 22 can be configured to operably couple to EAS field generation hardware, thereby enabling the EAS antenna 53 to provide an EAS field. In the exemplified embodiment, when the frame 22 is in the unextended position, the EAS antenna 53 is in an active state such that the EAS antenna 53 generates an EAS field in the POS lane 40. Further, when the frame 22 is transitioned from the unextended position to the extended position, the EAS antenna 53 transitions to an inactive state such that the EAS antenna 53 does not generate an EAS field in the POS lane 40. The EAS antenna 53 can be any antenna configured to provide an EAS field for detecting EAS tags. According to this embodiment, the gate 20 is configured to detect EAS tags within the POS lane 40 when the gate 20 is in the unextended position. In other embodiments, EAS functionality can be activated or deactivated by other states of the gate. For example, the EAS antenna can be activated by the gate being extended, or by a button on the gate, or remotely using a computer network.

EAS systems are well known and therefore are not discussed in detail herein. EAS systems can be used to detect and prevent theft. In general, such EAS systems employ security EAS tags and EAS gates. The tags are secured to the article to be protected and can be detected by an EAS gate. Such EAS gates are generally located at or around points of exit to detect the security tag, and thus the article, as it transits through the exit point.

Due to environmental and regulatory considerations, individual EAS gates are generally effective over only a limited area in which a security tag attached to a protected article may be reliably detected. Such area, typically referred to as a detection zone, is generally limited to about six feet in width. Thus, in many such situations, a plurality of EAS gates is required to fully protect a multiplicity of separate exit points.

The invention can utilize any type of EAS technology, including acousto-magnetic and magnetic. The exemplified embodiment uses radio frequency (RF) EAS technology. The RF tags include a self-contained passive resonant circuit in the form of a generally planar printed circuit which resonates at a predetermined frequency. The EAS gate for detecting the resonant circuit security tag includes a transmitter which transmits electromagnetic energy into the detection zone to form an electromagnetic field having frequency components proximate to the resonant frequency of the security tag. The EAS gate also includes a receiver to detect the electromagnetic field within the detection zone. When an article having an attached security tag moves into or passes through the detection zone, the security tag is exposed to the transmitted electromagnetic energy, resulting in the security tag resonating to provide an output signal, thereby disturbing the electromagnetic field within the detection zone. Such disturbance is detectable by the receiver. The detection of such field disturbance by the receiver indicates the presence of an article with a security tag within the detection zone and the receiver activates an alarm to alert security or other personnel.

The invention is not limited to RF EAS technology. In other embodiments, other types of EAS technology can be utilized. Further, radio frequency identification (RFID) can be used to provide EAS functionality, where the EAS gate 20 forms part of an RFID reader or interrogator.

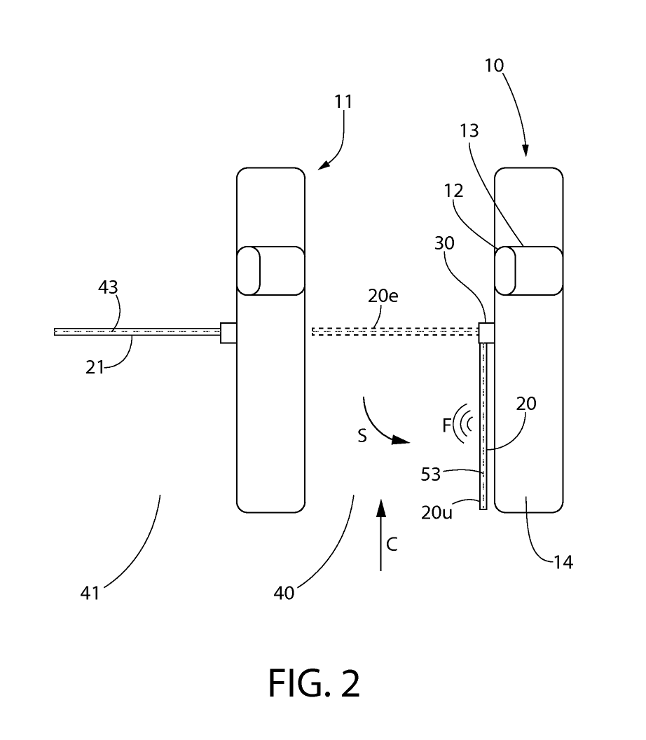

FIG. 2 shows a top view of the POS station 10 of FIG. 1 where the gate 20 has been transitioned to the unextended position. This view shows the register 12, scanner 13, and conveyor system 14 for a customer traveling in the POS lane 40 in direction C. The gate 20 was in the extended position 20e but has been swiveled in direction S to the unextended position 20u.

In the extended position, the gate 20 obstructs the POS lane 40 but does not emit an EAS field. Thus, customers may move into or near the POS lane 40 with tagged merchandise without the tags being detected and possibly sounding an alarm. In the unextended position 20u, however, the gate 20 emits an electromagnetic field F in the POS lane 40 for EAS detection. Thus, if a thief tries to exit the store through the POS lane 40 (e.g., when a store clerk is away from the POS station 10 or distracted), the gate 20 can cause an alarm. The EAS antenna 53 and field generation hardware can be configured such that the EAS field is focused in the POS path. Thus, a customer putting his items on the conveyor belt of a conveyor system will not cause an alarm, while a thief putting only some items on the conveyor belt will cause an alarm. Further, because the gate 20 is unextended, the EAS field can more easily be focused in the POS lane 40, preventing the gate 20 from detecting tags from customers passing by or near the POS lane 40. As stated above, in other embodiments, EAS functionality can be activated or deactivated by other states of the gate 20.

The exemplified embodiment of FIG. 2 further shows a second POS station 11 having a second gate 21 in an extended position. In this embodiment, the second gate 21 is in the extended position and is not generating an EAS field.

In the exemplified embodiment, each EAS gate 20, 21 includes hardware for generating an EAS field and receiving an EAS field disturbed by an EAS tag. Technology for enabling such transceiver functionality is well known and will be not discussed in detail. Such systems, for example, can use pulse-listen technology. In these systems, a transmitter repeatedly transmits a sequence of RF burst signals of electromagnetic energy at different frequencies such that the frequency of at least one of the bursts falls near the resonant frequency of a security tag to be detected. The EAS system turns the transmitter off between the bursts and enables the receiver during these quiescent periods of time. The receiver detects a security tag located within the detection zone by detecting the energy re-radiated by the resonant security tag during the quiescent periods.

In other embodiments, the EAS field is configured to be received by an EAS receiving antenna separate from the EAS antenna 53. In one embodiment, the EAS receiving antenna is a second antenna 43 forming part of the second gate 21 adjacent the second POS lane 41.

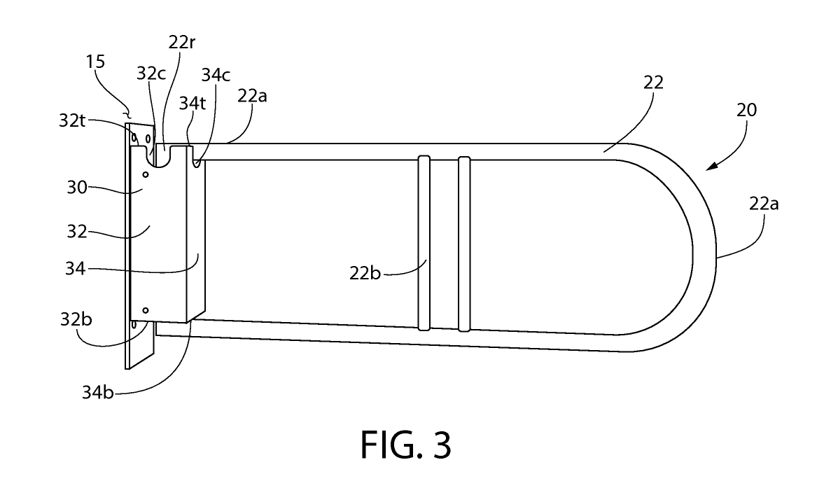

FIG. 3 is a front view of the gate 20 of FIG. 1. The gate 20 includes a frame 22 and a translation mechanism 30. In this embodiment, the frame 22 includes a peripheral portion 22a and an interior portion 22b. The peripheral portion 22a includes a frame resting portion 22r. In the exemplified embodiment, the frame 22 comprises hollow tubing, the EAS antenna 53 positioned within the hollow tubing. In other embodiments, the frame can be any structure for receiving or physically supporting an EAS antenna and obstructing a POS lane in an extended position, and in some embodiments the frame can be the antenna itself. For example, the frame can be hollow tubing of any kinds (e.g., plastic or steel), or can be a solid panel having the antenna wiring routed around and/or through the panel.

In the exemplified embodiment, the translation mechanism 30 with which the frame 22 interfaces is a swivel mechanism. The swivel mechanism 30 is attached to the stationary and substantially vertical surface 15 adjacent the POS lane 40 and enables the frame 22 to swivel between extended and unextended positions. The swivel mechanism 30 has a parallel surface 34 that is parallel to the substantially vertical surface 15 and a perpendicular surface 32 that is perpendicular to the substantially vertical surface 15. Each of the parallel surface 34 and the perpendicular surface 32 has a top edge 34t, 32t and a bottom edge 34b, 32b, each top edge 34t, 32t having a U-shaped cutout 34c, 32c in which the frame resting portion 22r of the frame 22 can rest. When the frame 22 is in the extended position, the frame resting portion 22r rests in the parallel surface U-shaped cutout 34c.

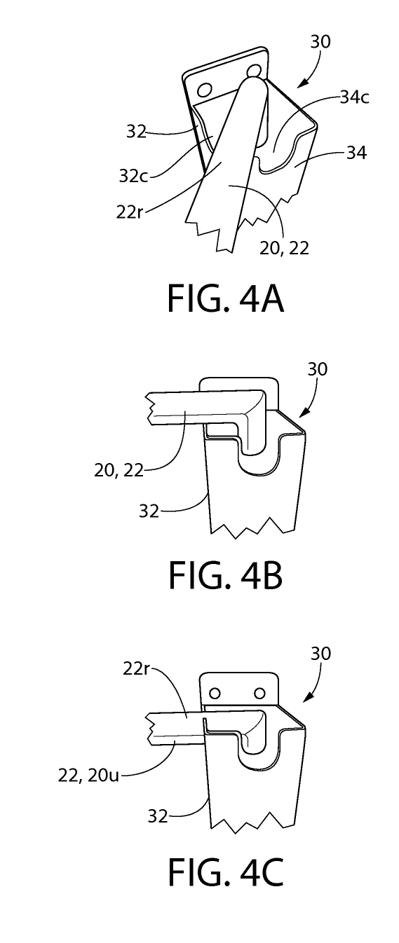

FIGS. 4A-4C shows the gate 20 of the exemplified embodiment transitioning from an extended position to an unextended position. In FIG. 4A, the frame 22 of the gate 20 has been lifted out of the cutout 34c of the parallel surface 34 of the swivel mechanism 30 and swiveled towards the cutout 32c of the perpendicular surface 32 of the swivel mechanism 30. The frame resting portion 22r no longer rests in cutout 34c. In FIG. 4B, the frame 22 of the gate 20 has been swiveled over the cutout 32c of the perpendicular surface 32 of the swivel mechanism 30. In FIG. 4C, the frame 22 has been swiveled approximately 90 degrees from the extended position of FIG. 3 to the unextended position 20u. The frame 22 has been lowered such that the frame resting portion 22r rests in the cutout 32c of the perpendicular surface 32 of the swivel mechanism 30. The cutouts 32c, 34c can be designed to engage the frame resting portion 22r such that the gate 20 is locked securely in the extended or unextended position. The swiveling mechanism can include a position locking feature that prevents movement of the gate 20 by applying a horizontal force on the gate 20.

As discussed above, the translation mechanism 30 is not limited to the exemplified swivel mechanism. In other embodiments, the translation mechanism can be any mechanism configured to transition the frame between an extended position and an unextended position.

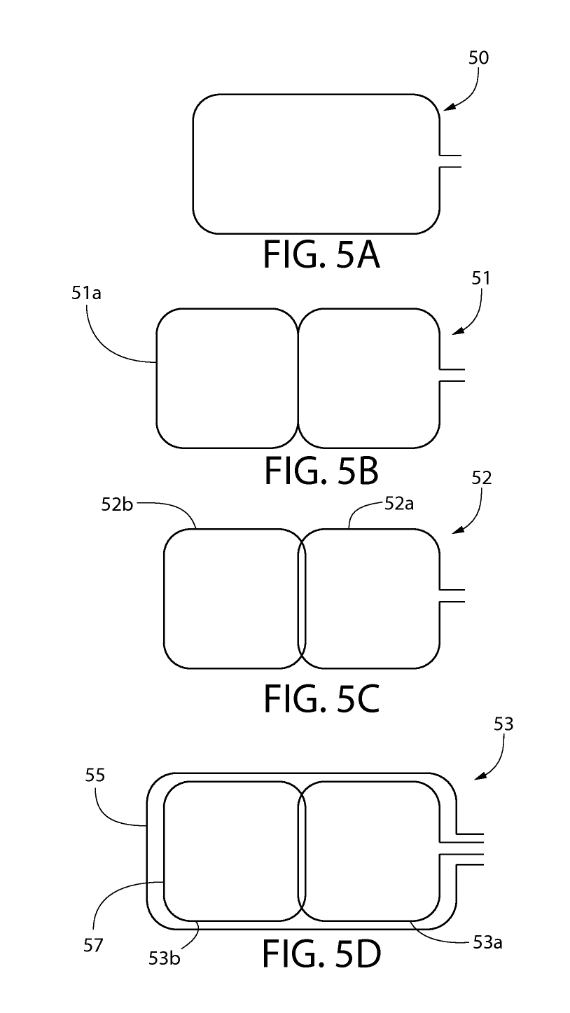

FIGS. 5A-5D are different antenna configurations according to different embodiments of the present invention. FIG. 5A shows a first antenna 50, sometimes referred to as a zero loop antenna. It is designed to start at the translation mechanism 30, extend along the periphery of the frame 22 of a gate, and return to the translation mechanism 30.

FIG. 5B shows a second antenna 52. This antenna 52 is similar to the first antenna 50, but crosses over itself at a midpoint to create a figure eight shape.

FIG. 5C shows a third antenna 52, sometimes referred to as a two-loop antenna. This antenna 52 has two loops—a first loop 52a and a second loop 52b. In one embodiment, the first loop 52a is similar to loop 50 of FIG. 5A (beginning and ending at the translation mechanism 30), and the second loop 52b is a separate loop that is positioned over a portion of the first loop 52a without physically contacting the first loop 52a. In other embodiments, the two loops can be in contact with each other.

FIG. 5D shows a fourth antenna 53, which is a combination of antennas 50 and 52. The antenna 53 has a peripheral portion 55 and a loop portion 57. The peripheral portion 55 is designed to extend along the periphery of a frame 22 similar to antenna 50. The loop portion 57 has a first loop 53a and a second loop 53b similar to antenna 52. The antenna of the invention is not limited to the above configurations. In other embodiments, the antenna can take any shape sufficient to provide EAS functionality.

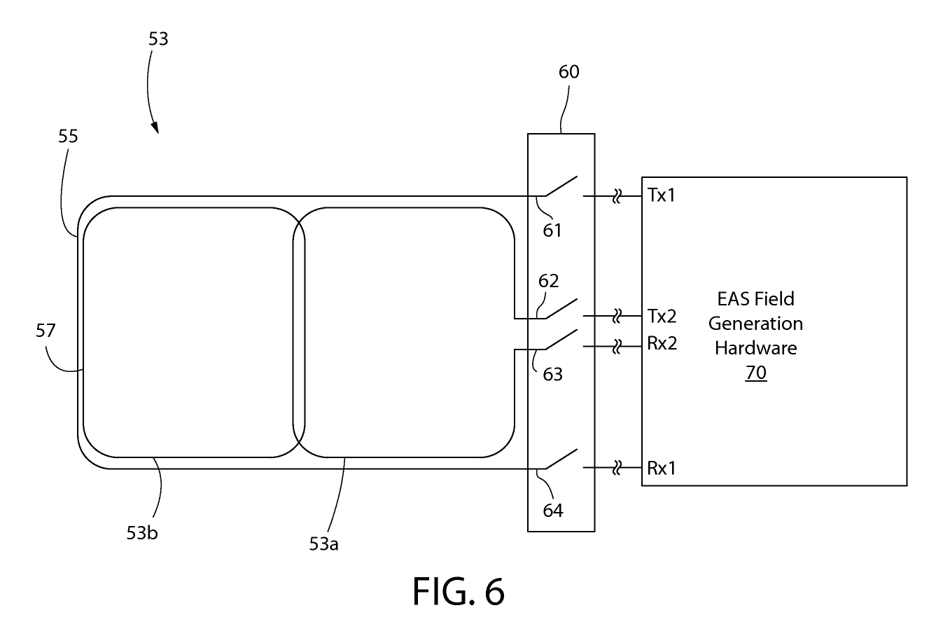

FIG. 6 is a schematic of antenna 53 switchably coupled to EAS field generation hardware 70 according to one embodiment of the present invention. The antenna 53 is in the same configuration as that shown in FIG. 5D, including a peripheral portion 55 and a loop portion 57 having a first loop 53a and a second loop 53b. The antenna 53 is connected to the EAS field generation hardware 70 through a switching mechanism 60. The EAS field generation hardware 70 can be any hardware or device sufficient to generate an EAS field for detecting EAS tags.

In the exemplified embodiment, the EAS field generation hardware 70 includes a first transmitter port TX1, a first receiver port RX1, a second transmitter port TX2, and a second receiver port RX2. The first transmitter port TX1 is coupled to the peripheral portion 55 of the antenna 53, the first receiver port RX1 is coupled to the peripheral portion 55 of the antenna 53, the second transmitter TX2 port is coupled to the loop portion 57 of the antenna 53, and the second receiver port RX2 is coupled to the loop portion 57 of the antenna 53. According to the exemplified embodiment, the peripheral portion 55 can be driven by the first transmitter port TX1, possibly at full power. The first receiver port RX1 may be switched off by setting the receiver hardware and software gain to zero, or by switch 64 of the switching mechanism 60. By switching the first receiver port RX1 off, the peripheral portion 55 may be transmit-only, that is, configured to transmit an EAS field but not receive a response EAS field. The peripheral portion 55 may be differentiated from other conventional EAS antennas because many conventional EAS antennas use such a zero loop as a ground loop and not as an active antenna element.

The loop portion 57 of the antenna 53 may be driven by the second transmitter port TX2 of the EAS field generation hardware 70, possibly at full power. The second receiver port RX2 may be used for EAS tag detection.

The peripheral and loop portions 55, 57 may be driven in this manner because the close proximity to the POS station may cause field interference with, for example, mild pressed steel cladding of the station. By driving the peripheral portion as described above, however, the shielding and cancelling effects of the steel are mitigated providing for higher performance operation. The invention is not limited to the above configuration. The invention can use any configuration whereby EAS field generation hardware 70 enables an EAS antenna to generate an EAS field.

In the exemplified embodiment, a switching mechanism 60 is provided to facilitate the transition of the EAS antenna 53 to the inactive state. The switching mechanism 60 can be any switching device sufficient to activate and deactivate generation of an EAS field. In the exemplified embodiment, the switching mechanism 60 switches when the gate 20 transitions from the extended position to the unextended position, or from the unextended position to the extended position. In the exemplified embodiment, the switching mechanism 60 includes switches 61, 62, 63, 64 for the respective EAS field generation hardware ports TX1, TX2, RX2, RX1. In one embodiment, the EAS field generation hardware 70 polls the position of the switching mechanism 60 to facilitate the transition of the EAS antenna 53 to the inactive state. In other embodiments, the switching mechanism 60 can simply cutoff electrical connection between the EAS antenna 53 and the EAS field generation hardware 70.

The gate 20 can further include a wiring harness housed within the translation mechanism 30, the wiring harness electrically connected to the antenna 53 and the switching mechanism 60. Further, the gate 20 can include additional switches to override or complement the switching mechanism 60. For example, in one embodiment, the gate can include a physical switch whereby a store clerk can deactivate the antenna. When this physical switch is in the OFF position, the antenna will not generate and EAS field, regardless of whether the gate is in the extended or unextended position. When this physical switch is in the ON position, the antenna will generate and EAS field if the gate is in the unextended position.

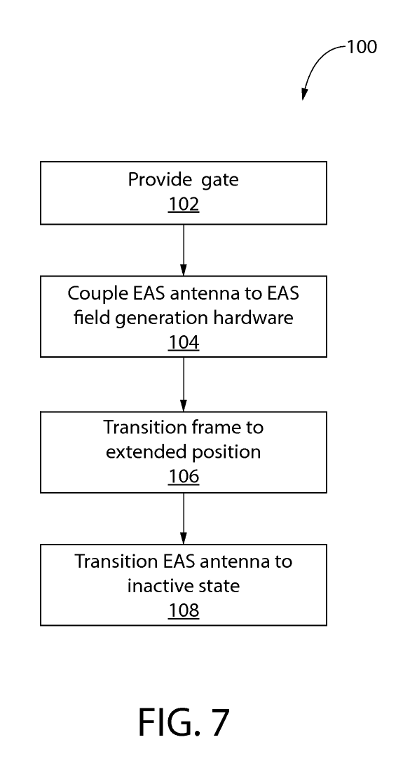

FIG. 7 is a flow chart of a method 100 according to one embodiment of the present invention. By this method, a gate 20 is provided for positioning adjacent a POS lane 40 (step 102). EAS field generation hardware 70 is operably coupled to the EAS antenna 53 (step 104). The frame 22 is transitioned from the unextended position to the extended position (step 106). In response, the EAS antenna 53 is transitioned from (a) an active state in which the EAS antenna 53 generates an EAS field in the POS lane 40 to (b) an inactive state in which the EAS antenna 53 does not generate an EAS field in the POS lane 40 (step 108). The invention is not so limited and can include other methods of implementing the disclosed gate 20.

The invention can further include a system comprising a gate 20 and EAS field generation hardware 70 operably coupled to the EAS antenna 53. In one embodiment, when the frame 22 is in the unextended position, the EAS antenna 53 is in an active state such that the EAS antenna 53 generates an EAS field in the POS lane 40, and when the frame 22 is transitioned from the unextended position to the extended position, the EAS antenna 53 transitions to an inactive state such that the EAS antenna 53 does not generate an EAS field in the POS lane 40.

While the invention has been described with respect to specific examples, those skilled in the art will appreciate that there are numerous variations and permutations of the above described invention. It is to be understood that other embodiments may be utilized and structural and functional modifications may be made without departing from the scope of the present invention. Thus, the spirit and scope should be construed broadly as set forth in the appended claims.

What is claimed is:

1. An apparatus comprising:
a frame;
a translation mechanism coupled to the frame and positioned adjacent a point of sale (POS) lane, the translation mechanism configured to transition the frame between an extended position and an unextended position, wherein in the extended position the frame extends into the POS lane and obstructs a person's passage through the POS lane, and in the unextended position the frame does not obstruct a person's passage through the POS lane; and
an EAS antenna coupled to the frame, the EAS antenna configured to operably couple to EAS field generation hardware;
wherein when the frame is in the unextended position, the EAS antenna is in an active state such that the EAS antenna generates an EAS field in the POS lane; and
wherein when the frame is transitioned from the unextended position to the extended position, the EAS antenna transitions to an inactive state such that the EAS antenna does not generate an EAS field in the POS lane.

2. The apparatus of claim 1 wherein the frame comprises hollow tubing, the EAS antenna positioned within the hollow tubing.

3. The apparatus of claim 1 wherein the translation mechanism is a swivel mechanism configured to swivel the frame between the extended position and the unextended position.

4. The apparatus of claim 3 wherein the swivel mechanism is configured to attach to a stationary and substantially vertical surface adjacent the POS lane.

5. The apparatus of claim 4 wherein the swivel mechanism comprises a parallel surface that is parallel to the substantially vertical surface and a perpendicular surface that is perpendicular to the substantially vertical surface, wherein:
each of the parallel surface and the perpendicular surface has a top edge, each top edge having a U-shaped cutout in which a frame resting portion of the frame can rest;
when the frame is in the unextended position, the frame resting portion rests in the U-shaped cutout of the perpendicular surface; and
when the frame is in the extended position, the frame resting portion rests in the U-shaped cutout of the parallel surface.

6. The apparatus of claim 1 wherein the antenna comprises:
a peripheral portion extending along a periphery of the frame; and
a loop portion comprising at least one loop.

7. The apparatus of claim 6 wherein the EAS field generation hardware comprises:
a first transmitter port coupled to the peripheral portion of the antenna;
a first receiver port coupled to the peripheral portion of the antenna;
a second transmitter port coupled to the loop portion of the antenna; and
a second receiver port coupled to the loop portion of the antenna.

8. The apparatus of claim 7 wherein the first receiver port is switched off such that the peripheral portion is configured to transmit the EAS field but not receive a response EAS field.

9. The apparatus of claim 8 wherein the loop portion is configured to transmit the EAS field and receive a response EAS field.

10. The apparatus of claim 9 wherein the loop portion comprises at least two loops.

11. The apparatus of claim 1 further comprising a switch, the switch facilitating the transition of the EAS antenna to the inactive state.

12. The apparatus of claim 11 wherein the EAS field generation hardware polls the position of the switch to facilitate the transition of the EAS antenna to the inactive state.

13. The apparatus of claim 1 wherein the EAS field is configured to be received by an EAS receiving antenna separate from the EAS antenna.

14. The apparatus of claim 1 wherein the EAS receiving antenna forms part of a gate adjacent a second POS lane.

15. The apparatus of claim 1 wherein the EAS antenna forms part of a radio frequency identification reader.

16. A system comprising:
a gate comprising:
a frame;
a translation mechanism coupled to the frame and positioned adjacent a point of sale (POS) lane, the translation mechanism configured to transition the frame between an extended position and an unextended position, wherein in the extended position the frame extends into the POS lane and obstructs a person's passage through the POS lane, and in the unextended position the frame does not obstruct a person's passage through the POS lane;
an EAS antenna coupled to the frame; and
EAS field generation hardware operably coupled to the EAS antenna;
wherein when the frame is in the unextended position, the EAS antenna is in an active state such that the EAS antenna generates an EAS field in the POS lane; and
wherein when the frame is transitioned from the unextended position to the extended position, the EAS antenna transitions to an inactive state such that the EAS antenna does not generate an EAS field in the POS lane.

17. The system of claim 16 wherein the antenna comprises:
a peripheral portion extending along a periphery of the frame; and
a loop portion comprising at least one loop.

18. The system of claim 17 wherein the EAS field generation hardware comprises:
a first transmitter port coupled to the peripheral portion of the antenna;
a first receiver port coupled to the peripheral portion of the antenna;
a second transmitter port coupled to the loop portion of the antenna; and
a second receiver port coupled to the loop portion of the antenna.

19. The system of claim 18 wherein the first receiver port is switched off such that the peripheral portion is configured to transmit the EAS field but not receive a response EAS field.

20. A method comprising:
providing a gate comprising:
a frame;
a translation mechanism coupled to the frame and positioned adjacent a point of sale (POS) lane, the translation mechanism configured to transition the frame between an extended position and an unextended position, wherein in the extended position the frame extends into the POS lane and obstructs a person's passage through the POS lane, and in the unextended position the frame does not obstruct a person's passage through the POS lane;
an EAS antenna coupled to the frame;
operably coupling EAS field generation hardware to the EAS antenna;
transitioning the frame from the unextended position to the extended position; and
in response to transitioning the frame from the unextended position to the extended position, transitioning the EAS antenna from (a) an active state in which the EAS antenna generates an EAS field in the POS lane to (b) an inactive state in which the EAS antenna does not generate an EAS field in the POS lane.
